(19) United States
(12) Patent Application Publication
(10) Pub. No.: US 2008/0065606 A1
(43) Pub. Date: Mar. 13, 2008

(54) Method and Apparatus for Searching Images through a Search Engine Interface Using Image Data and Constraints as Input

(76) Inventors: Donald Robert Martin Boys, Redding, CA (US); Susan Araiza-Boys, Redding, CA (US)

Correspondence Address: CENTRAL COAST PATENT AGENCY, INC, 3 HANGAR WAY SUITE D, WATSONVILLE, CA, 95076, US

(21) Appl. No.: 11/849,637

(22) Filed: Sep. 4, 2007

Related U.S. Application Data
(60) Provisional application No. 60/843,250, filed on Sep. 8, 2006.

(51) Int. Cl. G06F 17/30

(52) U.S. Cl. 707/3

(57) ABSTRACT

A system for searching for image data based on a likeness constraint of the image data to candidate image data submitted as search criteria includes a network appliance having access to servers on the network and access to candidate image data, a server running a search interface application, the server having access to image data available over the network, and a software suite for formatting and analyzing images and for creating image signatures unique to analyzed images.

### CROSS-REFERENCE TO RELATED APPLICATIONS

The present invention claims priority to U.S. provisional patent application 60/843,250, entitled “Method and Apparatus for Image Searching Through a Search Engine” and filed on Sep. 8, 2006, disclosure of which is included herein by reference.

### BACKGROUND OF THE INVENTION

1. Field of the Invention

The present invention is in the field of data searching as practiced over the Internet network through a search engine interface and pertains particularly to methods and apparatus for searching images located on the World Wide Web.

2. Discussion of the State of the Art

Search engines are available services that a user can access on a network like the Internet network through a browser interface. The primary function of a search engine is to return Web addresses of electronic information pages that match a text input of key words or phrases. The way the basic search engine function works is that a user enters some text keyword, series of keywords or a phrase into a field provided in a search dialog box. The input is forwarded to a server that parses the information and then searches databases for files using spiders and other robotic methods for keyword relevant documents, articles, web-sites, and so on which contain the keywords or phrases. The search engines finds these, sorts them by percentage of match, and then returns the URLs, termed hits, to those items to the user and displays them in a list for the user to browse through.

More recently, search engines have been enhanced with capability for searching for media files of both audio and video types including still images that are relevant to consumer-entered keyword data. Categories are available at the keyword entry box interface that may be selected to narrow a search, for example, to certain file types of audio or video or graphics. The results of such search interactions comprise a list of URLs to Web pages supporting those items.

A limitation to this technology is apparent in searching for image files. For example, the existing technology focuses on descriptive keywords that may be associated to descriptive text of images located on the Web. The result is that the user may receive numerous hits from which to select, however many of those hits are not worthwhile because the images associated with those hits are not related to what the user really had in mind. For example, typing in the text keyword dog will result in returned links to a wide variety of images such as real photographs of dogs, cartoon pictures of dogs, word-art images that are not images of dog but of the word dog, and so on. Furthermore, many images will be of doghouses, dog kennels, dog trainers, and other non-related images that a user must sort through. Search refinement techniques can narrow the search of images but there is still no control over facets of the images themselves in terms of what is returned.

What is clearly needed is a way to enable images to be searched based on submitting an image or image data and/or text constraints as query data or search engine criteria. Such a system would enable a variety of valuable services and would eliminate much work related to image sorting or browsing for a user.

### SUMMARY OF THE INVENTION

The inventor provides a system for searching for image data based on a likeness constraint of the image data to candidate image data submitted as search criteria. The system includes a network appliance having access to servers on the network and access to candidate image data, a server running a search interface application, the server having access to image data available over the network, and a software suite for formatting and analyzing images and for creating image signatures unique to analyzed images.

In one embodiment, the network is the Internet network including connected sub-networks supporting Internet protocols. In one embodiment, the candidate image data submitted is a digital image signature of the form of a machine-readable code. In this embodiment, the machine-readable code is one of a binary data string, a coded script, or a machine-readable command.

In one embodiment, the candidate image data submitted is a candidate digital image. In one embodiment, the network appliance is a computer. In another embodiment, the network appliance is a hand-held device. In a preferred embodiment, the likeness constraint is percentage-based. In one embodiment, the server is a public search server hosted by a search services provider. In one embodiment, the server hosts the software suite. In another embodiment, the software suite is distributed to the server and to the network appliance.

According to another aspect of the present invention, in a network-based image search service, a method is provided for searching for image data based on a likeness constraint of the image data to candidate image data submitted as search criteria. The method includes the steps (a) receiving at the service, the submitted candidate image data with other search criteria, (b) formatting the candidate image data to adhere to an image format standard, (c) analyzing the candidate image data to define and quantify image attribute or image feature values, (d) creating an image signature unique to the candidate image data, the image signature carrying the values derived from step (c), and (e) searching for other image signatures pre-created using steps (b)-(d) that match the candidate signature according to the likeness constraint.

In one aspect of the method, the network is the Internet network including connected sub-networks supporting Internet protocols. In one aspect in steps (a), (b), and (c) the candidate image data is a digital image. In one aspect in step (b), the image signature is a binary string or a machine-readable script. In a preferred aspect in step (e), the likeness constraint is a percentage of likeness of a searched image signature to the candidate image signature. In one aspect in step (a), the other search criterion includes one or a combination of keywords or phrases, object position descriptors, and likeness constraint percentage.

According to another aspect of the present invention in a network-based image search service, a method is provided for searching for image data based on a likeness constraint of the image data to candidate image data. The method includes the steps (a) submitting an image signature derived from analyzing a candidate image with other criteria to the image search service, (b) at a service point on the network, using the image signature of step (a) to search for other image signatures created from analyzing searchable images the searchable image signatures indexed in the database and filtered in part according to the other criteria, and (c) receiving at an endpoint on the network search results including thumbnails and location data of images matched by image signature to the candidate image signature.

In one aspect of the method, the network is the Internet network including any connected sub-networks supporting Internet protocols. In one aspect in step (a) the other criteria includes keywords or phrases and a percentage of likeness constraint.

According to still another embodiment of the present invention, an image analyzer is provided for analyzing digital images and for creating digital signatures unique to images analyzed. The image analyzer includes a portion thereof for formatting an image for analysis to a standard format, a digital processing layer including image analysis components, a signature writer for writing a machine-readable signature carrying values derived from analysis, and an interface to a database application to store digital image signatures created.

### BRIEF DESCRIPTION OF THE DRAWING FIGURES

FIG. 1 is an architectural overview of a communication network supporting image search technology according to an embodiment of the present invention.

FIG. 2 is a block diagram illustrating client/server interaction according to embodiments of the present invention.

FIG. 3 is a process flow chart illustrating steps for producing an image signature according to an embodiment of the present invention.

FIG. 4 is a process flow chart illustrating steps for using image search according to embodiments of the present invention.

FIG. 5 is a block diagram of the image analyzer signature mapping software of FIGS. 1 and 2 according to an embodiment of the present invention.

FIG. 6 is a process flow chart illustrating database preparation for image searching according to an embodiment of the present invention.

FIG. 7 is a block diagram illustrating a signature map of an image and additional search criteria for returning image locations according to an embodiment of the present invention.

### DETAILED DESCRIPTION

The inventor provides a system and methods including software for enabling an image search function for a public search engine that accepts search keywords and/or phrases, an image signature, and filtering constraints as criteria for returning locators to images that resemble a candidate image analyzed to produce the image signature.

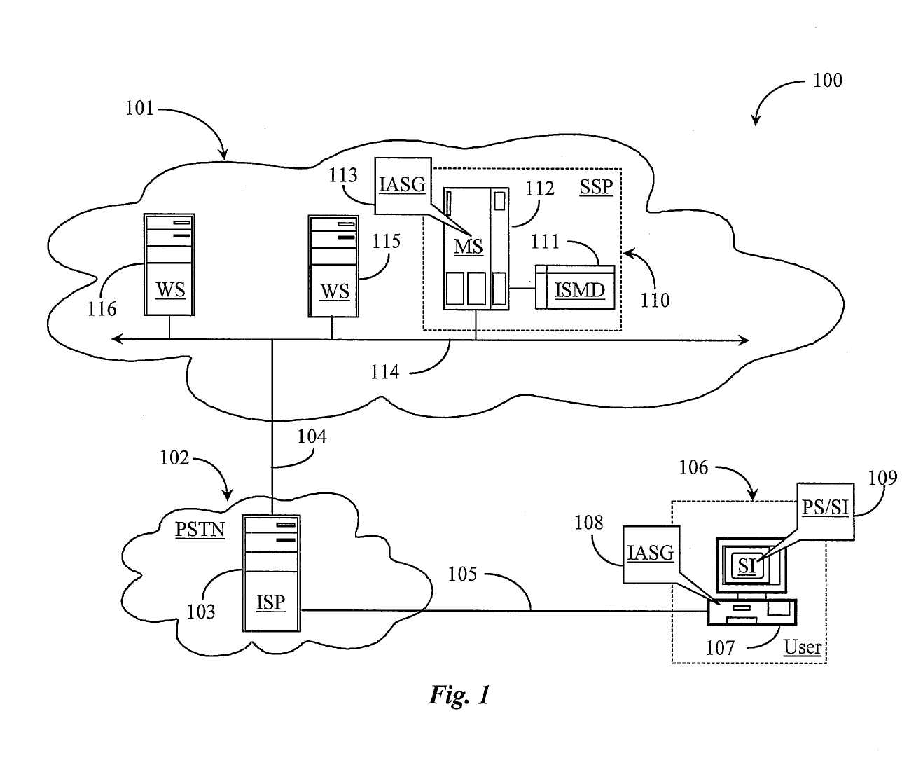

FIG. 1 is an architectural overview of a communications network 100 supporting image search technology according to an embodiment of the present invention. Network 100 includes a wide-area-network (WAN) 101, which may be a corporate or public WAN including a municipal area network (MAN) or an Internet network. In preferred embodiments of the present invention, the Internet network or World Wide Web (WWW) is used because of its high public access characteristic. Network 101 is defined more specifically by a network backbone 114. Network backbone 114 includes all of the lines, equipment, and access infrastructure including sub-networks that make up the Internet network as a whole. Therefore, there are no geographical limits to the practice of the present invention.

Internet network 101 includes a search services provider (SSP) 110 that is adapted as a business entity who provides network search services to network consumers. SSP may be any one of a number of existing well-known search service providers like Yahoo™, AlataVista™, Excite™, or a host of others who may be adapted with software to practice the present invention.

In conventional image search technology SSP 110 provides an index to images found on the World Wide Web whereby consumers performing searches against those images use a server-side interface to enter descriptive keywords or phrases to search for those images. In one embodiment of the present invention, SSP 110 is enhanced with a capability of filtering image search results with data derived from a candidate image submitted by a user with the intent on returning results to the user that more closely match the image type that the user is looking for.

SSP 110 includes an image mapping server (MS) 112 with an instance of image analysis signature (IASG) software (SW) 113 provided thereto and executable thereon. MS 112 with the aid of SW 113 can crawl web pages such as may be maintained in Web servers (WS) 115 and 116, and retrieve images for the purpose of formatting those images to a standard form. MS 112 with the aid of SW 113 then analyzing those images to create image signature maps of those images. An image signature map is a binary or other type of computer readable data string that includes values, which are derived from various digital image-processing (DIP) routines used by MS 112 in analyzing an image after converting that image to a universal standard format.

Image signature maps created from image analysis may be indexed along with image location data such as universal resource locators (URLs) and descriptive key words and/or phrases that describe the images in an image signature map database (ISMD) 111. Repository 111 may be any type of data repository adapted to store indexed data typical of search engine databases. MS 112 may scrape images for analysis but typically may not retain actual images but may retain the location data to those images.

WS 115 and 116 represent any type of server on the network that might retain image data such as images that are embedded in or displayed on hyper-text-transfer-protocol (HTML) Web sites or electronic information pages created using sister or similar protocols including wireless application protocol, and others. One with skill in the art of network-based data storage will appreciate that image data accessible over a network may also be stored on home computer systems such as in a shared folder wherein such data may be accessible using point-to-point (PPP) network protocols. A search service provider may in some embodiments index such image data as long as the user device or machine is accessible over the network.

One with skill in the art of data search technology will appreciate that SSP 110 may include other machine types than are illustrated in this example such as machines that support bots and web crawler applications responsible for locating and indexing data and other software implements used in indexing user submissions to the search service provider. Such equipment and software implements may be assumed present in an embodiment of a general SSP enhanced to practice the present invention. Similarly, the invention may be practiced as an image search service only using the components of the present invention without offering other search services as long as image location and URL indexing services are available directly or indirectly to the entity practicing the invention.

Communications network 100 includes a user domain 106, which may be a home-based domain or any business domain. User domain 106 represents any consumer of network services and includes any entity that has a network-capable appliance for accessing the network and navigation capability for interfacing with SSP 110. In this embodiment, user domain 106 includes a desktop computer 107. Any other network-capable appliance might be substituted for computer 107 such as a cellular telephone, a personal digital assistant, an Internet capable interactive radio or music player, a laptop computer, or the like. The minimum requirements for a device are a processor, a display, a data input apparatus, and a network browser.

In this example, computer 107 has connection to Internet backbone 114 of network 101 via a telephone line to an Internet Service Provider (ISP) 103 illustrated herein in a public switched telephone network (PSTN) 102. It will be appreciated by one skilled in the art of telephony and network access technology that there are a number of other ways that computer 107 or another network-capable appliance may access network 101. In this example a telephone modem is used. In other applications, cable/modem, broadband connection, digital service subscriber line (DSL), integrated services digital network (ISDN), wireless modem, wireless fidelity (WiFi), and other methods could be used including local area network (LAN) based connection. In this example, ISP 103 has connection to network backbone 104 via an Internet access line 104, which may be a high-speed carrier.

Computer 107 has an instance of image analyzer signature (IASG) mapping SW 108 provided thereto and executable there from in one embodiment so that a user operating from domain 106 may perform image analysis and signature mapping of images accessible to the user such as those in storage on computer 107, or those accessible to the station that may be stored on a peripheral device like a jump drive, a camera, or other device with memory. In this example, computer 107 is logged on to network 101 through ISP 103 and is displaying a public search/search interface provided by SSP 110 enhanced for practicing the present invention.

In this case, the user operating from station 107 has an option of submitting a candidate image for server side analysis, in which case MS 112 aided by SW 113 creates a signature map of the submitted image for use with other criteria in an image search with the intent of returning location data to like images filtered by a percentage constraint and typical text keywords. The user also has the option of analyzing the candidate image locally (client-side) with the aid of SW 108 instead of submitting the actual image and just submitting the signature map of the image along with the other mentioned data. It is noted herein that typical keyword and phraseology presently used to search image data is specifically required in all embodiments in order to practice the present invention.

A user may search using only the signature map and a constraint that indicates a percentage of likeness that the user wishes to be applied to filter the search results. A percentage constraint may identify a percentage or a range of percentages prioritized in the results listing. For example, a user may specify that all results returned should match the submitted signature map by 80%. The user may also specify a range like from 80% likeness down to 70% acceptable with the higher percentage results listed first. Like traditional search services thumbnails of the images may be displayed along with URLs and other associated descriptive data.

A user also has the option of adding the typical keywords or phraseology to the image search as an additional filtering tool. In one embodiment, the user may add one or more additional constraint keywords that might be descriptive of the object position in the candidate image, for example, front-full body profile or side-full body profile. Other descriptive constraints may also be used like perspective profile, rear-profile, head profile, frontal view, side view, perspective view, etc. This is not required in order to practice the present invention; however the invention may be provided as an additional filtering tool for narrowing the results field to images that more closely resemble what the user is looking for. More detail about the possible methods for searching for images according to embodiments of the invention is provided later in this specification.

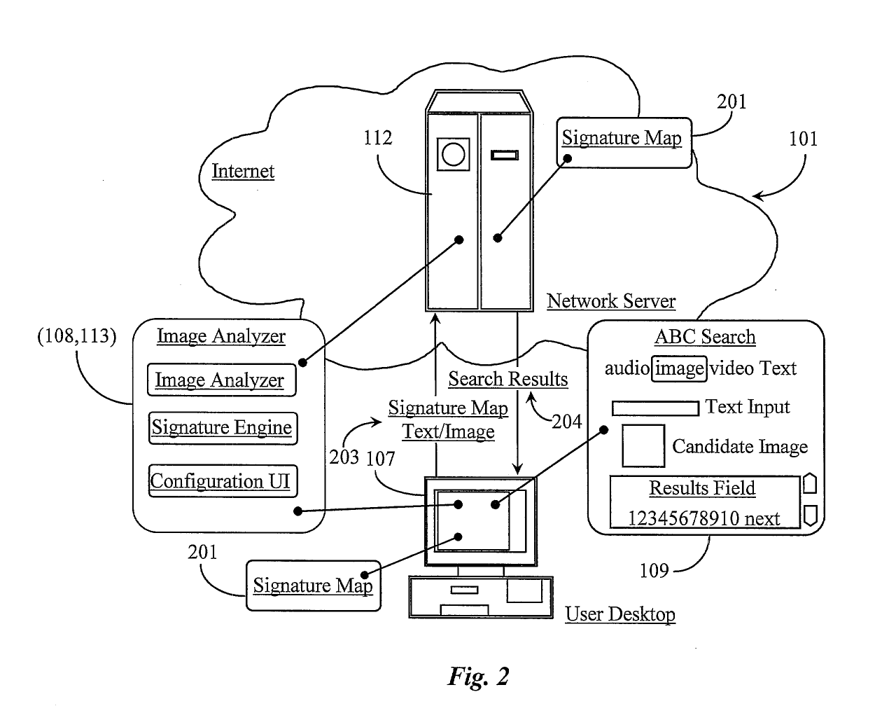

FIG. 2 is a block diagram illustrating client/server interaction according to embodiments of the present invention. In this embodiment, server 112 and/or computer 107 may be running image analyzer software (108, 113) as was illustrated further above with respect to FIG. 1. Image analysis may take place on computer 107 (client-side) or on server 112 (server-side) without departing from the spirit and scope of the present invention. Image analysis SW (108, 113) includes, in this example, an image analyzer, a signature-mapping engine, and a configuration user interface (UI). In one embodiment, the image analyzing SW may be a separate application from the signature mapping SW without departing from the spirit and scope of the present invention.

SW (108, 113) is used to create a signature map 201 from values derived from image analysis of a candidate image. Signature map 201 may be a series of concatenated binary strings reflecting several values derived from different digital image processes used in analyzing the candidate image, the values presented in an identifiable order in the string. In one embodiment, the signature map is a machine readable code having the specific values of the image analysis embedded therein or otherwise listed in some identifiable order or pattern in the code. The result of image analysis of a candidate image is signature map 201 whether the process is performed client-side or server-side. Signature map 201 is unique to the candidate image that was analyzed to derive the values in the map. Any other image that is not the same image will have a different signature map unique to that image. The image analyzer SW may be configurable by a user using a UI to specify which of more than one digital image processes will be used on an image to derive the signature map of the image. Redundancy filters may also be provided to cancel out static values that may be present in the same value for all images of a standardized format that might be analyzed to produce signature maps. The configuration of the image analyzer should be pre-set and static before the service of the invention is practiced for searching multiple images in order to maintain integrity of the percentage of likeness of images returned during any search performed.

In this example, computer 107 has interface 109 displayed. Interface 109 may be any existing search engine interface that may be enhanced by the present invention. In this case ABC search interface 109 has options for searching audio, image, video, and text with the user selecting image search to practice the invention. In this example, there is minimally a text input field and a candidate image input field. The candidate image field is adapted to accept a digital image has search input. The text field is adapted to accept one or more text constraints related to image likeness and, possibly, image object position. Interface 109 causes a results field or page to be displayed that lists the search results. The search results page is typically a browser-based page generated and served to users and that contains the search results for the last search task performed. Elements of the search interface template remain in the results page for search refinement, task continuance, and the like. In some embodiment, results may be returned in a results field generic to the search interface.

The candidate image and text constraint or constraints are submitted to server 112 via interface 109. In this case, server 112 creates a signature map of the candidate image submitted and performs a search for indexed signature maps based on the one or more constraints. For example, if a constraint is to match the image 100%, then the service would have to find the a signature map that matches exactly to the signature map created and the results would only include the exact same picture. This might be useful, for example, to search for websites that have posted an image without permission thus violating a copyright owned by the user wherein the candidate image submitted is owned and copyrighted by the user.

In one embodiment, the constraint or constraints may specify an 80% likeness to the candidate image submitted. In this case, server 112 would look for signature maps that mathematically match the one created by 80% or higher. It is noted herein that all images analyzed to create a signature map are first converted into a universal standard format before they are processed for signature values.

Image format standards may include, but are not limited to image size and resolution (pixel count), color or gray-scale rating, file extension, and compression type and ratio. The actual images pointed to in a search result list are accessible in their native formats. The search service formats the images and analyzes them to create signature maps in one embodiment, but does not retain any actual formatted images but may simply use the created signature maps as part of the image-indexing scheme already in place at the service. Standardizing the image formats is practiced to prevent abuse of the system and to maintain integrity of the signature mapping process.

In one embodiment, a format for adding text keywords and/or phraseology and for adding additional constraint data is provided wherein all of the input may be submitted through one entry field in the search engine interface. For example, keywords may be entered followed by a separator then constraint data followed by a separator, then a signature map. Alternatively, dedicated fields may be provided in the search interface, one for typical search terms or phrases, one for constraint data, and one for a signature map. In one embodiment, the actual candidate image is submitted with the aforementioned text data in the same session instead of a signature map (server-side analysis).

In typical interaction during a session between computer 107 and server 112, the computer may submit a signature map, text, or text and an image for processing and search execution. The server may return URLs to images and other relevant data associated with the locations of those images. It is noted herein that a user may analyze images on the fly for creating and submitting signature maps to a search service. In one embodiment, a user may pre-analyze and create signature maps for a portion of or all of the stored images that are accessible to the user. In this case, the signature maps created may be stored with the image data in some ordered format such as via tagging or appending the signature map to the image from which it was derived. In one embodiment, a pointer to the signature map for an image may be added to the image data packet header.

Digital Image Processing techniques may be used to analyze an image for the purpose of creating a signature map of the image. Image histogram and color histogram analysis may be used. Edge detection, line transform, interest point analysis, blob detection, corner detection, gray-scale histogram, texture mapping, curvature detection, spatial analysis, and other well-known DIP techniques may be used along with specific algorithms to produce values that can be included in a signature map of the image.

The image analyzer may use mathematical routines like averaging, multiplication, division, and quantification in conjunction with image analysis to help create single values for DIP categories. Color analysis can include color intensity averages, contrast averages, color palette analysis, and like analysis. Static information about the image such as pixel count, resolution, and any other data that remains identical from image to image because of conversion to a standard format can be filtered out or ignored altogether to focus on the differences from image to image. In a preferred embodiment, each process in image analysis used to create a signature value for an image should be accurate enough produce the same or near the same value if run on the same image a second time. A margin for error may be acceptable for each DIP function and the margin may be accumulative in overall processing so long as one may still match within reason a single image to the same image using a signature map and a 100% constraint matching criteria.

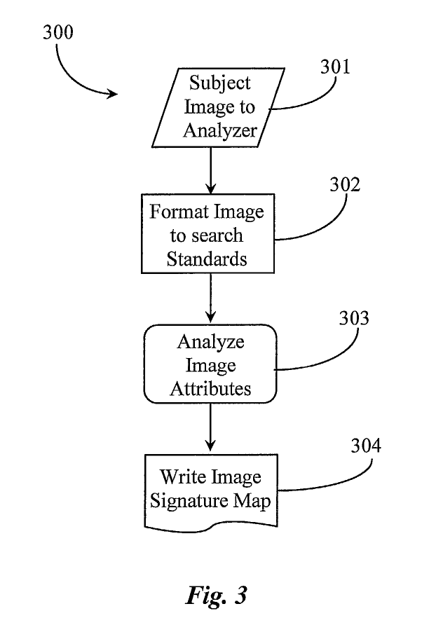

FIG. 3 is a process flow chart illustrating basic steps 300 for producing an image signature according to an embodiment of the present invention. Steps 300 may be practiced on a local network appliance (client-side) or in a server (server-side) at a service providing image search services according to an embodiment of the present invention. At step 301, a subject or candidate image is subjected to the image analyzer. A drag and drop technique may be used in one embodiment, or the analyzer may be configured to enable browsing and selection of images to analyze. In one embodiment, an analyzer may accept batch of multiple images to analyze sequentially creating signature maps for each image.

At step 302, the image is converted to a pre-ordained and standard image format before any analyzing is undertaken. In this way, the integrity of the signature mapping process and results return is maintained. At step 303, the candidate image is analyzed using existing DIP processes for detecting image attributes and for assigning, deriving, and/or or extrapolating values that can be used in the signature map. Important feature detection routines like line, edge, curvature, point and texture routines may include pre-process routines that change or alter image attributes slightly to obtain a better result. However, such pre-routines do not result in any permanent change in the image attributes.

In step 304, an image signature map is created from the derived values defining various attributes of the image that are not static from image to image. In this step, further mathematical processing may be performed on categorical values. For example, multiple X, Y coordinates may be quantified and averaged to reflect an overall value. Date compression or encoding techniques may be used to produce a value for a specific attribute as long as those same routines are repeated image for image on the specific attribute that is analyzed.

The signature map may be a machine readable code having multiple values representing different attributes of the analyzed image ordered in presentation so that they may be read the same way during signature map matching. A signature map may be a concatenated binary string of ordered values.

In one embodiment, a special reader may be implemented in software that can read each signature map and may determine to a percentage of what portion of that signature map matches a given or candidate signature map that might be submitted during a search. Such a reader and matching routine may be integrated in conventional results processing software as a filter. For example, if a user submits a signature map or a candidate image to be processed to derive a signature map, the image search results may be first filtered by those that include signature maps, then those that match keywords, then those that fall into the correct percentile of match to the given signature map. In a preferred embodiment a search services provider or an entity providing the service of the present invention has all accessible or indexed images pre-processed and indexed by the image signature maps in addition to any other indexing pointers or criteria.

In one embodiment, conventional results-filtering software is used to read a signature map and to determine a percentage of match of that signature map to a given signature map. In this case, the signature map may be expressed in script such as Extensible markup language (XML), or some derivative of XML. Other machine-readable scripts may also be used to present the signature map values. In a preferred embodiment, images are not compared with each other. The image matching process looks for signature maps of images that match a given signature map used as criteria in the search according to a percentage of likeness ordered by the searcher and, perhaps other constraints. A signature map that is identical or near identical to a given signature map within an acceptable margin of error will likely be the same exact image expressed in the standardized format. The actual images that the search results point to need not be posted in the standardized format in order to get a match. Thumbnails of the index3d images may also be presented along with the search results as is the present case in most image search engines.

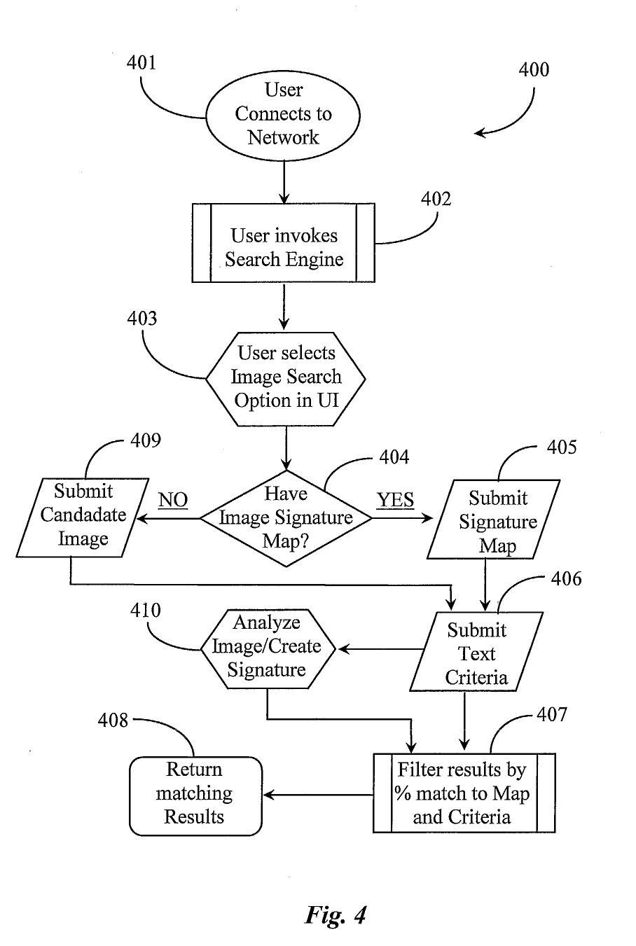

FIG. 4 is a process flow chart illustrating steps 400 for using image search according to embodiments of the present invention. In step 401, a user connects to the network, which may be the Internet network in one embodiment. In step 402, the user invokes a search engine interface, typically by double clicking on an appropriate icon or menu item in the browser while connected. Step 402 results in display of an interactive search engine interface that may be an existing interface enhanced with fields for entering a signature map and/or a candidate image. Either a candidate image or a signature map may be submitted as part of the search criteria without departing from the spirit and scope of the present invention.

At step 403, the user selects an image search option from within the interface indicating that an image search will be conducted. At step 404, the user determines whether or not a signature map is available to use as search engine input. If the user has a signature map of the image to which the user seeks like images, then at step 405 the user submits the signature map. This may be accomplished by copy and paste or drag and drop method. In one embodiment, the user may type a signature map; however this may not be preferred in some embodiments. At step 406, the user may submit text criteria related to the search task such as typical keywords or phrases. In addition to or in place of the usual keyword submission, the user may enter a “percentage of likeness” constraint or select it from a drop-down menu. Still further in one embodiment the user may additionally enter one or more object orientation constraints related to the central theme of the image. For example, if the user is searching for human face shots in the image then “frontal; face” may be entered to aid the narrowing process.

At step 407, the search service having received all of the criteria for a search, performs the search against its databases and filters the results by the percentage of likeness constraint (signature mapping) and the other entered criteria. At step 408, the server returns the results over the network to the user, the results displayed according to any set priority including percentage of likeness.

In one embodiment, the user does not have a signature map at step 404. It may be that all of the processing is server-side. In this case, at step 409 the user submits a candidate image that is the subject of a search to return like images. The process resolves then to step 406 where the user submits the text criteria. The process then diverts to step 410 where the submitted image is received and processed, and a signature map is created for that image. Step 410 includes converting the image to the standard format if not already received in the standard format. Analyzing the image and creating the signature for the image may be performed in a same process. The received image may not be retained by the service unless the user grants permission to the service to retain the original image.

Once the image is processed and the image signature map is available, the service uses the signature map and submitted criteria to search and filter results in step 407. At step 408 the results are returned to the user over the prevailing network. In one embodiment, the image processing is done with a local application (client-side). In the other embodiment, the image processing is performed server-side. In the case of server-side processing exemplified in the process including step 410, the processing may be done on the fly and the data used in the search including the image and image signature map may be discarded after the search is performed.

In another aspect of this process variation, the service may retain the image and the signature map for the user if requested to do so for further search tasks or for automated updating. For example, a user may submit a candidate image for processing and the signature map of that image may be retained by the service for use in subsequent searches to update search results periodically for the user. In this case, automated searches may be ordered periodically, say one time per week, and any new results could be sent to the user or stored for access by the user.

A practical use for such a service might be to monitor to see if one who took a picture of the user and promised not to publish that picture on the network actually kept the promise. Another might be to monitor to see if eventually a product similar the one I am seeking and submitted an image of is finally available for sale over the network. Perhaps a user wants to buy a second home that looks very similar to the user's first home and has submitted an image of his first home and has searched to 90% likeness to the signature map of that image but has not yet encountered a result that is satisfactory. Continued searching may turn up a satisfactory match once the similar image is posted, analyzed, and a signature map is created for the image in the search engine index.

In one variation of the process, a user may not have a signature map at hand in step 404. In this case, the user may select a candidate image and then process it for a signature map on the fly wherein the results of the process are automatically entered into the interface on behalf of the user. In this case, the signature map may be transparent to the user that is to say that the user does not see or retain the signature map. The scope of the image analyzer software may vary somewhat according to the processing capabilities of the host device. For example, a desktop version may contain more DIP functionality that a light version for a cellular telephone. However, most hand-held devices have sufficient processing capabilities and speed to practice the present invention optimally. Research and development in DIP continues and more accurate image analysis features are continually being developed that require less processing power to execute. Similarly, DIP algorithms are available to the inventor that may eliminate redundant calculations saving time.

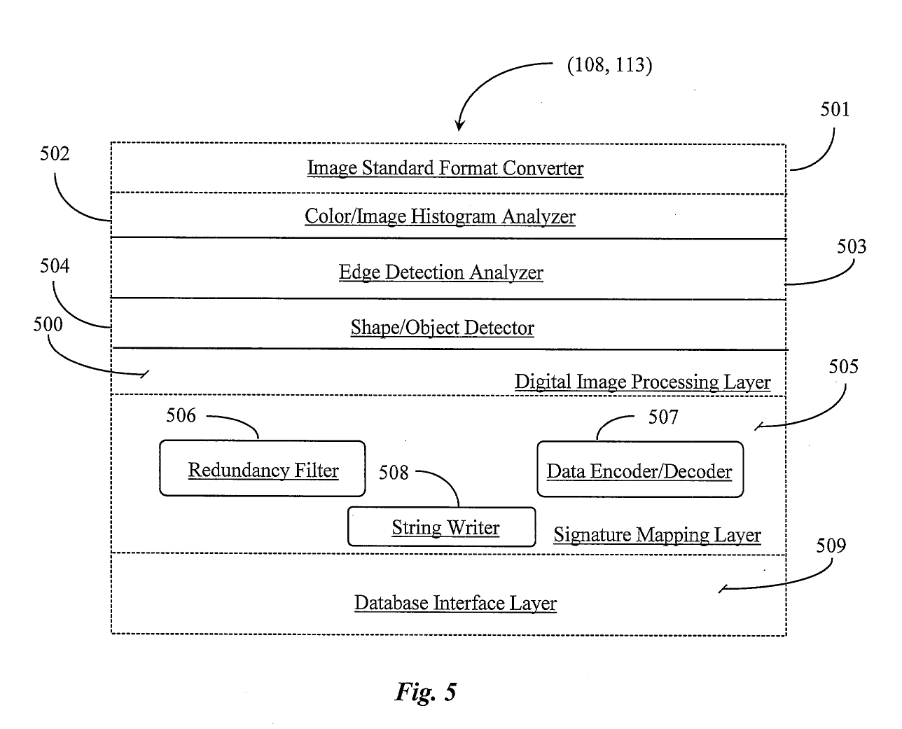

FIG. 5 is a block diagram of image analyzer signature mapping software (108, 113) of FIGS. 1 and 2 according to an embodiment of the present invention. Image analyzer and signature mapping SW may be provided as one application in different versions. The application is given two different element numbers in FIG. 1 only to show different hosts for the application. Application 108 may be identical to application 113. In this example, reference number 113 shall refer to either instance 113 or 108.

Application 113 includes an image format converter 501 that is adapted to convert a native image format into a standard format accepted for image search. It is not required that format converter 501 be integrated with application 113 to practice the present invention. Format converter 501 may be a standalone application used in conjunction with application 113. In this example, it is a part of the application. Format converter 501 may convert any image to an accepted format including file extension, compression type and ratio, and image resolution. More subtle attributes may also be standardized like, initial sharpness, contrast, brightness, and other image properties. In a preferred embodiment, a standard image format is desired as a pre-requisite to image analysis and signature map creation. Application 113 includes a digital image processing layer 500 that contains various image analyzer components or modules.

DIP layer 500 may include an image histogram analyzer 502 to determine histogram properties of the image. The module may include components for producing a color histogram, an overall image histogram, a gray-scale histogram, and histogram equalization results. DIP layer 500 may include an edge detection analyzer that is adapted to detect the edges of objects in an image. There are many different methods used for edge detection, any one of which or a combination of which may be included in application 113.

DIP layer 500 may include a shape/object detector 504 in this example. Shape/object detector 504 may not rely on typical edge detection criteria in order to define shapes or objects in an image. Therefore, modules 503 and 504 may compliment each other in function to help produce a more accurate value or value set. One with skill in the art of image analysis will appreciate the different techniques that make up the general categories of edge detection and shape or object recognition. In one embodiment, pattern recognition may be included in the image analysis process or the present invention. In this case, some pattern recognition intelligence may be required in the form of common patterns stored in a database.

Application 113 includes a signature-mapping layer 505. Layer 505 contains various components that may be used relative to producing a unique signature for a processed image. Layer 505 accepts result values from the components within DIP layer 500 and creates a signature map that is machine-readable and that contains the values that are unique to the image analysis.

In one embodiment, layer 505 includes a redundancy filter 506. Filter 506 may comprise one or more algorithms that are used to cancel and values that are routinely static from image to image irrespective of the values that are uniquely different for different images. Layer 505 may also include a data encoder/decoder 507. Data encoder/decoder 507 may be used to compress or encode data to minimize the length or complexity of an uncompressed signature map. Likewise, the decoder portion may be used to automatically decode the map during reading of the map to determine likeness of signature maps to a given signature map.

Layer 505 may include a string writer 508 or equivalent writer for producing the final data string, script, or other machine-readable code that is the image signature map presenting the resulting values of analysis in an ordered fashion so that they may be compared to a given string of values to determine likeness between the signatures.

Application 113 includes a database interface layer 509. Layer 509 contains all of the required components for writing the signature maps into storage and for associating those signature maps to the appropriate stored images in one embodiment. In one embodiment, the only signature maps that are stored are those created from images found on the network and indexed into the system by the search service provider. These signature maps and other data may be included in the search engine indexing data for matching purposes. In one case, the user may also pre-analyze images and store signature maps for use as input to an image search. In one case, the service provider may store signature maps with or without images on behalf of a user to use in automated search updates.

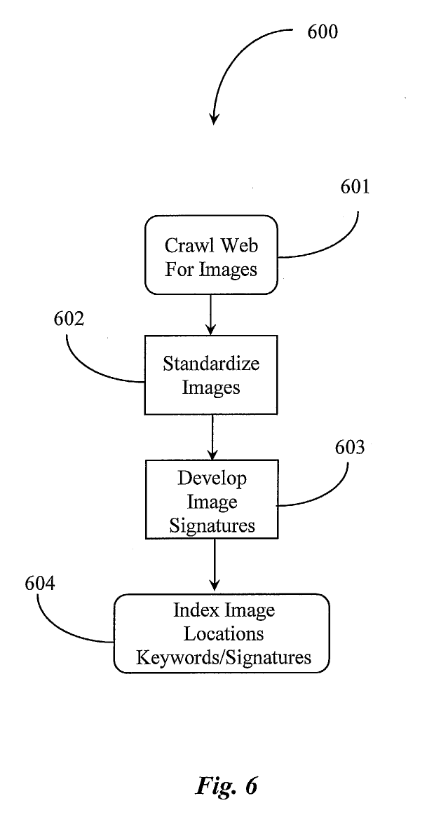

FIG. 6 is a process flow chart illustrating database preparation step[s 600 for image searching according to an embodiment of the present invention. In act 601, a search services provider enhanced with the SW of the present invention may crawl or otherwise navigate the network using web crawlers bots or other automated programs to locate images for indexing into an image search service. In one embodiment images or web pages with images may also be submitted to the service for indexing.

At step 602, the service obtains the images in question and converts copies of those images into a standard format reference for image analysis. In one embodiment, screen-scraping techniques may be used to obtain the images for formatting. In step 603, the images are processed to develop the signature maps of those images. In step 603, the image is submitted in standard format to the image analyzer and signature mapping SW and signature maps are produced for each of the images.

In one embodiment of the present invention, the service may perform steps 602 and 603 of the process virtually, that is to say that no image data is uploaded to the service. In this case, the service locates images and processes them remotely and only takes the image location data and descriptors and the signature maps created for use in filtering the images later in a search. In this embodiment, the process of the invention may be integrated into the web crawling process.

At step 604, the search service provider indexes image locations, descriptors, keywords, and signature maps into the search databases for use in image search. The service periodically revisits the sites hosting the images to update those sites as normally would be the case.

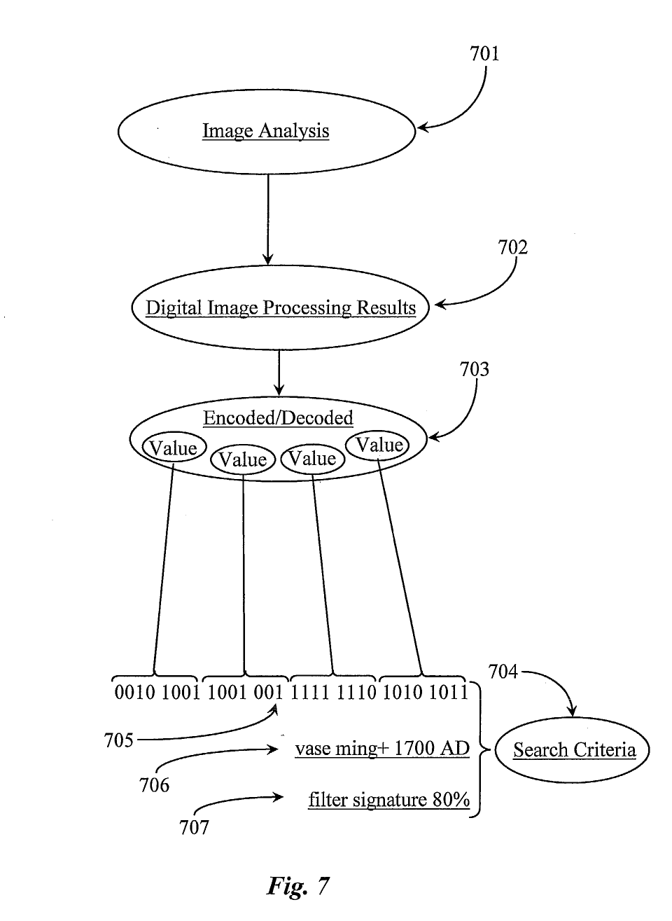

FIG. 7 is a block diagram illustrating a signature map of an image and additional search criteria for returning image locations according to an embodiment of the present invention. The user performs an image analysis 701, in this example to obtain digital image processing results 702, which are the resulting values of various image analysis functions performed. Optionally, those results may be encoded by an encoder/decoder 703 before values are included in a signature map of the image. In the case of encryption or encoding, the service may also include a decoder for use in comparing signature maps for likeness.

Search criteria 704 submitted by a user includes, in this example, a signature map 705, keyword data 706, and likeness constraint data 707 expressed in this example as a percentage constraint for matching signatures. In this example, the signature map is a binary string presenting the values in binary format in an ordered fashion. In this example, the user has an image of a Ming vase dating back to the year 1700 and wishes to see if another Ming vase of that time is available anywhere and advertised or otherwise posted somewhere on the network. The user is happy with returns of an 80% likeness to the image submitted in the form of a signature map in this case, to the service.

The process of the present invention greatly reduces the amount of browsing and text keyword refinement or re-entry that a user may typically encounter when searching for images of a specific likeness. For example, the signature map of a color image of a real object automatically eliminates any images of cartoon animations of the object, or other images of other representations the object in question like a sign that says vase, for example. Further refinement through image analysis enables edge and shape matching, texture matching color matching and other similarities between images to be exploited. The results are real images that have a user-ordered likeness to the image that the user has in mind.

One with skill in the art of data searching will recognize that the methods and apparatus of the present invention may be used to provide a wide array of public services. For example, a dating service might be provided whereby a user may submit a candidate image of a person that interests them from an attraction point of view. Through signature mapping, the service may return only profiles of users whose image signatures match the submitted image/signature by a percentage constraint ordered by the searching user.

In a security application, a user may have an image of a terror suspect and as part of the investigation or attempt to locate the person in the image, the user may submit the image/signature to the search service provider to see if that image or one very much like it is posted somewhere on the Internet. A user who submits an image/signature to the service with a 100% likeness constraint for a return result may be looking for copyright violators or to determine if the exact same image has made its way to the Internet.

Other applications are plausible and practical using the methods of the present invention. For example, a real-estate buyer may submit an image/signature of a home style that is particularly desired by the user. The image may be one taken by the user of a home near the user that was desired but not for sale at the time. A search may return hits to like homes having the same or very similar architecture style posted on the networks that are for sale. The methods and apparatus of the present invention may be used in certain product marketing areas such as car sales to quickly browse available cars based on signature of an image of a car that is desired. In application, an interior decorator may submit an image/signature of a lamp in order to find one that matches. An art collector may submit an image of a painting to find other paintings that are close in style of work.

One with skill in the art will agree that overall accuracy in matching images based solely upon signature comparison may vary somewhat depending on image content and the scope of image analysis performed to create the image signatures. One technique to improve accuracy is adding specific standards related to image content before analysis. For example, if the service involves much searching for images of humans, then a standardized pose may be ordered for images used by that service such as a specifically ordered frontal shot from the waist up a certain distance from the camera. Analysis then may focus more on color, such as hair color, facial tone, eye color. Curvature analysis can narrow from the basic torso image form to match head shape, body shape, etc.

In one embodiment, the methods and apparatus of the present invention can be used in a non-network application local to the client. For example, a bird watcher may use an image capture device that is enhanced with the image analyzer and signature mapping software of the present invention. Additionally the device may have a smart card or other memory containing pre-loaded signature maps and descriptions including the names of birds likely to be photographed by the bird watcher using the image capture device. In this case, when the birdwatcher snaps an image, the image may be processed onboard the camera for the signature of the image. The image signature may then be compared to the other image signatures pre-loaded in memory to retrieve the closes matching signature. The definitive caption may then be annotated to the image that was taken, thus identifying the bird that was captured in image. Later, the image may be compared to a field guide to validate the identification without doubt. In this embodiment, a standard image formatting should be observed as well to maintain the integrity of the signature matching process. For example, capturing an image of a bird where the bird is much smaller or larger in the picture than the birds of the pre-loaded signatures will likely result in some error.

In the above embodiment, the pre-loaded signature maps of the bird images may include standardized content like a side profile, a front profile, and an in-flight profile of the bird. Therefore, one bird may have 3 pre-loaded image signature maps, one for each profile likely to be captured in a photo by the bird watcher. A formatter on the image capture device may reformat the captured image, for example to enlarge or shrink a profile that otherwise is smaller than standard. Image resolution may be set to a minimum standard; for example, if the captured image is too blurry then an error message may prompt the user to take another picture. This embodiment is not limited to birds per say as it may be applied to wildlife identification in general, or in other applications where identifying something captured in a photo is important.

It will be apparent to one with skill in the art that the image search system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system for searching for image data based on a likeness constraint of the image data to candidate image data submitted as search criteria comprising:
a network appliance having access to servers on the network and access to candidate image data;
a server running a search interface application, the server having access to image data available over the network; and
a software suite for formatting and analyzing images and for creating image signatures unique to analyzed images.

2. The system of claim 1, wherein the network is the Internet network including connected sub-networks supporting Internet protocols.

3. The system of claim 1, wherein the candidate image data submitted is a digital image signature of the form of a machine-readable code.

4. The system of claim 1, wherein the candidate image data submitted is a candidate digital image.

5. The system of claim 3, wherein the machine readable code is one of a binary data string, a coded script, or a machine readable command.

6. The system of claim 1, wherein the network appliance is a computer.

7. The system of claim 1, wherein the network appliance is a hand-held device.

8. The system of claim 1, wherein the likeness constraint is percentage-based.

9. The system of claim 1, wherein the server is a public search server hosted by a search services provider.

10. The system of claim 1, wherein the server hosts the software suite.

11. The system of claim 1, wherein the software suite is distributed to the server and to the network appliance.

12. In a network-based image search service, a method for searching for image data based on a likeness constraint of the image data to candidate image data submitted as search criteria comprising the steps:
a. receiving at the service, the submitted candidate image data with other search criteria;
b. formatting the candidate image data to adhere to an image format standard;
c. analyzing the candidate image data to define and quantify image attribute or image feature values;
d. creating an image signature unique to the candidate image data, the image signature carrying the values derived from step (c); and
e. searching for other image signatures pre-created using steps (b)-(d) that match the candidate signature according to the likeness constraint.

13. The method of claim 12, wherein the network is the Internet network including connected sub-networks supporting Internet protocols.

14. The method of claim 12, wherein in step (a), (b), and (c) the candidate image data is a digital image.

15. The method of claim 12, wherein in step (b), the image signature is a binary string or a machine-readable script.

16. The method of claim 12, wherein in step (e), the likeness constraint is a percentage of likeness of a searched image signature to the candidate image signature.

17. The method of claim 12, wherein in step (a) the other search criteria includes one or a combination of keywords or phrases, object position descriptors, and likeness constraint percentage.

18. In a network-based image search service, a method for searching for image data based on a likeness constraint of the image data to candidate image data comprising the steps:
(a) submitting an image signature derived from analyzing a candidate image with other criteria to the image search service.
(b) at a service point on the network, using the image signature of step (a) to search for other image signatures created from analyzing searchable images the searchable image signatures indexed in the database and filtered in part according to the other criteria; and
(c) receiving at an endpoint on the network search results including thumbnails and location data of images matched by image signature to the candidate image signature.

19. The method of claim 18, wherein the network is the Internet network including any connected sub-networks supporting Internet protocols.

20. The method of claim 18, wherein in step (a) the other criteria includes keywords or phrases and a percentage of likeness constraint.

21. An image analyzer for analyzing digital images and for creating digital signatures unique to images analyzed comprising:
a portion thereof for formatting an image for analysis to a standard format;
a digital processing layer including image analysis components;
a signature writer for writing a machine-readable signature carrying values derived from analysis; and
an interface to a database application to store digital image signatures created.
